(19) United States
(12) Patent Application Publication
(10) Pub. No.: US 2026/0328843 A1
(43) Pub. Date: Oct. 22, 2026

(54) PROCESSOR INCLUDING BUILT-IN SELF-TEST CIRCUIT, METHOD OF OPERATING THE PROCESSOR, AND METHOD OF MANUFACTURING THE SAME

(71) Applicant: Samsung Electronics Co., Ltd., Suwon-si (KR)

(72) Inventors: Sungho KANG, Seoul (KR); Jongho PARK, Seoul (KR)

(73) Assignees: Samsung Electronics Co., Ltd., Suwon-si (KR); UIF (University-Industry Foundation), Yonsei University, Seoul (KR)

(21) Appl. No.: 19/647,095

(22) Filed: Apr. 14, 2026

(30) Foreign Application Priority Data
Apr. 18, 2025 (KR) 10-2025-0051148

(51) Int. Cl. G01R 31/3185; G01R 31/3183; G01R 31/319

(52) U.S. Cl. CPC G01R 31/318547; G01R 31/318385; G01R 31/31921; G01R 31/318536

(57) ABSTRACT

A processor includes a scan chain including a plurality of scan cells connected in a chain, the scan chain configured to scan-in an input signal sequentially to the plurality of scan cells, store the input signal as a test pattern, and scan-out a test response from a circuit-under-test based on the test pattern, a pattern generating circuit generates a first test pattern based on a pseudo-random pattern, a second test pattern based on a deterministic pattern, and transmits the first test pattern and the second test pattern to the scan chain, the circuit-under-test comprises a logic circuit coupled to the plurality of scan cells, and a compacting circuit configured to output a signature by compacting the test response of the circuit-under-test. The pattern generating circuit generates a portion of the first and second test pattern based on an output signal of one scan cell of the plurality of scan cells.

### CROSS-REFERENCE TO RELATED APPLICATION(S)

This U.S. non-provisional application claims priority under 35 USC § 119 to Korean Patent Application No. 10-2025-0051148, filed on Apr. 18, 2025, in the Korean Intellectual Property Office, the disclosure of which is herein incorporated by reference in its entirety.

### BACKGROUND

Some example embodiments relate to a processor, and more particularly to, a processor including a built-in self-test (BIST) circuit, a method of operating the processor, and a method of manufacturing the same.

Field testing during the use of a processor is may be essential to ensuring stable operation of the processor. Limiting and/or preventing field failures in processors is especially relevant to the reliability of devices in automotive, railway, satellite, aerospace, telecommunications, and medical fields.

A Built-In-Self-Test (BIST) circuit may be used in integrated circuits to improve the reliability of processors. The BIST circuit may include a circuit configured to test patterns and a circuit configured to compress test responses.

A BIST circuit may have a lower test coverage than Automatic Test Equipment (ATE). The BIST circuit and deterministic patterns may be used together to improve the test coverage of the BIST circuit. The deterministic patterns may be configured to be prestored in the processor, so that the processor has sufficient overhead of a memory space used to store the deterministic patterns.

### SUMMARY

Some example embodiments provide a built-in self-test (BIST) circuit with improved test coverage that is implemented using a significantly reduced memory space.

Some example embodiments provide a BIST circuit with improved test coverage that is implemented using pseudo-random patterns.

According to some example embodiments, a processor includes a scan chain including a plurality of scan cells connected in a chain, the scan chain configured to scan-in an input signal sequentially to the plurality of scan cells, store the input signal as a test pattern, and scan-out a test response from a circuit-under-test based on the test pattern, a pattern generating circuit configured to generate a first test pattern based on a pseudo-random pattern, generate a second test pattern based on a deterministic pattern, and transmit the first test pattern and the second test pattern to the scan chain, the circuit-under-test comprising a logic circuit coupled to the plurality of scan cells, and a compacting circuit configured to output a signature by compacting the test response of the circuit-under-test. The pattern generating circuit is further configured to generate at least a portion of the first test pattern and the second test pattern based on an output signal of at least one scan cell of the plurality of scan cells.

According to some example embodiments, a method of operating a processor includes generating a first test pattern based on a pseudo-random pattern, scanning-out a first test response of a circuit-under-test based on the first test pattern, generating a second test pattern based on a deterministic pattern, scanning-out a second test response of the circuit-under-test based on the second test pattern, and outputting a signature by compacting the first test response and the second test response. At least a portion of the first test pattern and the second test pattern is based on an input signal input to a scan chain in a previous clock cycle.

According to some example embodiments, a method of manufacturing a processor includes obtaining a fault list of a circuit-under-test, determining a first test pattern based on a pseudo-random pattern for detecting first faults in the fault list, detecting at least a portion of second faults and determining a second test pattern based on a deterministic pattern, the second faults including faults corresponding to the first test pattern and excluding the first faults, and storing information of the first test pattern and a compressed pattern of the second test pattern in a memory circuit. The first test pattern comprises a modified pseudo-random pattern, the modified pseudo-random pattern including a last bit value among a plurality of bits of the pseudo-random pattern, the last bit value being configured to change to a previous bit value every predetermined bit period.

### BRIEF DESCRIPTION OF DRAWINGS

FIG. 1 is a conceptual block diagram illustrating a processor according to one or more example embodiments.

FIG. 2 is a block diagram illustrating a processor in detail according to one or more example embodiments.

FIG. 3 is a diagram illustrating a pattern generating circuit according to one or more example embodiments.

FIG. 4 is a diagram illustrating an operation of generating a first test pattern of a pattern generating circuit according to one or more example embodiments.

FIG. 5 is a diagram illustrating an operation of a second pattern generating circuit according to one or more example embodiments.

FIG. 6 is a diagram illustrating first test patterns according to one or more example embodiments.

FIG. 7 is a diagram illustrating an operation in which a pattern generating circuit generates a second type of first test pattern according to one or more example embodiments.

FIG. 8 is a diagram illustrating an operation of generating a second test pattern of a pattern generating circuit according to one or more example embodiments.

FIG. 9 is a diagram illustrating a conversion table between a compressed pattern and bit information according to one or more example embodiments.

FIG. 10 is a diagram illustrating an operation in which a pattern generating circuit generates a second test pattern based on bit information according to one or more example embodiments.

FIG. 11 is a flowchart illustrating a method of operating a processor according to one or more example embodiments.

FIG. 12 is a flowchart illustrating an operation in which a processor generates a first test pattern according to one or more example embodiments.

FIG. 13 is a diagram illustrating an operation in which a processor generates a first test pattern according to one or more example embodiments.

FIG. 14 is a flowchart illustrating an operation in which a processor generates a second test pattern according to one or more example embodiments.

FIG. 15 is a flowchart illustrating a method of manufacturing a processor according to one or more example embodiments.

FIG. 16 is a flowchart illustrating a method of determining a first test pattern, in the method of manufacturing a processor according to one or more example embodiments.

FIG. 17 is a diagram illustrating a method of determining a first test pattern, in the method of manufacturing a processor according to one or more example embodiments.

FIG. 18 is a flowchart illustrating a method for determining a second test pattern, in the method of manufacturing a processor according to one or more example embodiments.

FIG. 19 is a diagram illustrating a method for compressing a second test pattern, in the method of manufacturing a processor according to one or more example embodiments.

### DETAILED DESCRIPTION

The following description with reference to the accompanying drawings is provided to assist in a comprehensive understanding of various example embodiments of the present disclosure.

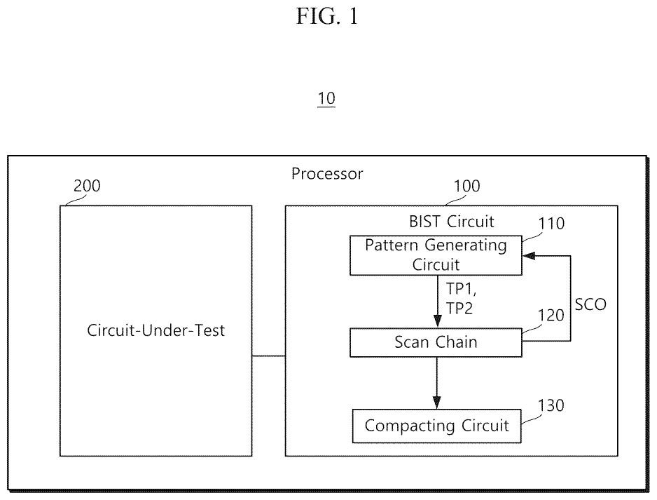

FIG. 1 is a conceptual block diagram illustrating a processor 10 according to one or more example embodiments.

The processor 10 according to one or more example embodiments may include a Built-In-Self-Test (BIST) circuit 100. The BIST circuit 100 may include a pattern generating circuit 110, a scan chain 120, and a compacting circuit 130. The pattern generating circuit 110 may generate a first test pattern TP1 and a second test pattern TP2. The pattern generating circuit 110 may generate at least a portion of each of the first test pattern TP1 and the second test pattern TP2 based on an output signal of a scan cell among a plurality of scan cells of the scan chain 120.

Referring to FIG. 1, the processor 10 may include a BIST circuit 100 and a Circuit-Under-Test (CUT) 200.

In one or more example embodiments, the processor 10 may include a plurality of BIST circuits 100 for each CUT 200.

The CUT 200 may be a logic circuit performing at least a portion of the functions of the processor 10 in a normal mode. The CUT 200 may be a test target of the BIST circuit 100 in a test mode. The CUT 200 may be a portion of a module or a portion of a logic circuit of the processor 10.

The BIST circuit 100 may be a logic BIST (LBIST) circuit performing a test on the logic circuit.

The BIST circuit 100 may input the test patterns TP1 and TP2, generated by the pattern generating circuit 110, to the CUT 200 through the scan chain 120. The compacting circuit 130 may compact a test response output by the CUT 200.

In one or more example embodiments, the BIST circuit 100 may generate a signature from the compacted test response. In one or more example embodiments, the BIST circuit 100 may compare the generated signature with a pre-stored signature and determine a fault of the CUT 200 based on a comparison result.

The BIST circuit 100 according to one or more example embodiments may generate a first test pattern TP1 based on a pseudo-random pattern and a second test pattern TP2 based on a deterministic pattern.

The first test pattern TP1 may include at least one of a pseudo-random pattern or a modified pseudo-random pattern.

In one or more example embodiments, the pattern generating circuit 110 may generate a plurality of types of first test patterns TP1. For example, the pattern generating circuit 110 may generate a first type of the first test pattern TP1 and a second type of the first test pattern TP1.

The second test pattern TP2 may be based on a deterministic pattern generated by an automatic test pattern generator (ATPG) of automated test equipment (ATE) based on a logically synthesized circuit. For example, a compressed pattern based on the deterministic pattern may be stored in a memory circuit of the processor 10, and the pattern generating circuit 110 may generate the second test pattern TP2 based on the compressed pattern.

The scan chain 120 may have a structure in which a plurality of scan cells are connected in a serial chain.

The pattern generating circuit 110 may receive an output signal of at least one scan cell among the plurality of scan cells of the scan chain 120 and generate at least a portion of each of the first test pattern TP1 and the second test pattern TP2 based on the output signal.

For example, the pattern generating circuit 110 may modify the pseudo-random pattern using the output signal of at least one scan cell, among the plurality of scan cells, and generate a modified pseudo-random pattern.

For example, the pattern generating circuit 110 may generate the second test pattern TP2 from bit information converted from the compressed pattern using the output signal of at least one scan cell, among the plurality of scan cells.

The processor 10 according to one or more example embodiments may generate both the first test pattern TP1 based on a pseudo-random pattern and the second test pattern TP2 based on a deterministic pattern using the same subset of circuits of the pattern generating circuit 110. Accordingly, the test coverage of the BIST circuit 100 may be improved.

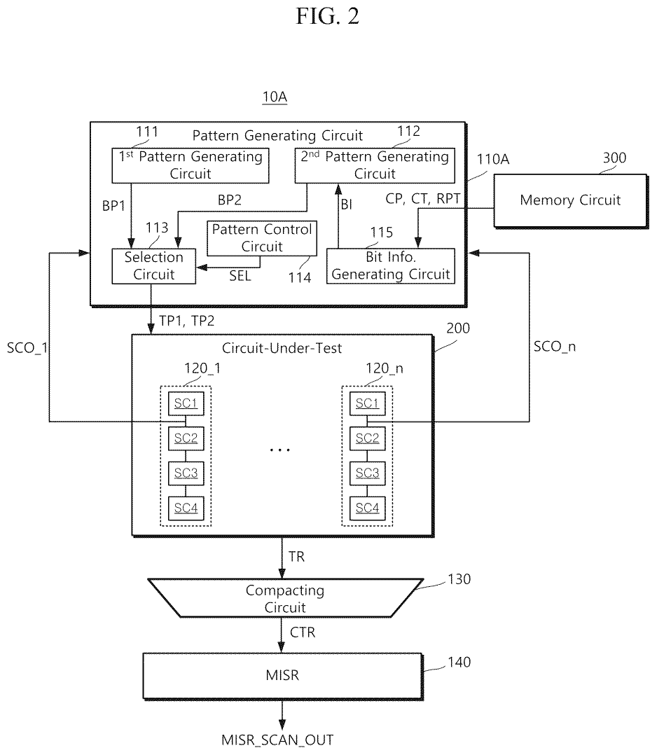

FIG. 2 is a block diagram illustrating a processor according to one or more example embodiments in detail.

FIG. 2 is a block diagram illustrating a processor 10A according to one or more example embodiments in detail. The processor 10A of FIG. 2 may correspond to the processor 10 of FIG. 1.

Referring to FIG. 2, the processor 10A may include a pattern generating circuit 110A, a plurality of scan chains 120_1 to 120_n, where n is a positive integer greater than or equal to 2, a compacting circuit 130, and a multiple input signature register (MISR) 140.

The pattern generating circuit 110A may generate the first test pattern TP1 and the second test pattern TP2. For example, the pattern generating circuit 110A may generate the first test pattern TP1 in a first test mode and generate the second test pattern TP2 in a second test mode.

The test patterns TP1 and TP2 may be scanned into the plurality of scan chains 120_1 to 120_n.

Each of the scan chains 120_1 to 120_n may include a plurality of scan cells. Each of the scan cells may include a flip-flop or a latch. In the present specification, an example is provided in which a scan cell includes a flip-flop, but the scan cell may also include an element other than the flip-flop. The scan cell may include a multiplexer. In FIG. 2, each of the scan chains 120_1 to 120_n is illustrated as including four scan cells SC1, SC2, SC3, and SC4, but the scan chains 120_1 to 120_n may include a larger or smaller number of scan cells.

The scan cells included in each of the scan chains 120_1 to 120_n may be connected to each other in a serial chain. For example, at least a portion of the flip-flops included in the CUT 200 may be connected in a chain through a scan design.

In a scan-in mode, bits of the test patterns TP1 and TP2 may be sequentially shifted in (“shift-in”) to the scan chains 120_1 to 120_n.

The CUT 200 may output a test response TR based on the test patterns TP1 and TP2. For example, the processor 10A may perform a circuit operation based on the test patterns TP1 and TP2. A test response TR, a result of the circuit operation, may be stored in the scan cells.

The test response TR may be scanned out from the scan chains 120_1 to 120_n. For example, the test response TR may be shifted out (“shift-out”) to the scan chains 120_1 to 120_n, and the scanned-out test response TR may be input to the compacting circuit 130.

The MISR 140 may generate a signature MISR_SCAN_OUT from the compacted test response CTR and output the signature MISR_SCAN_OUT.

According to one or more example embodiments, the processor 10A may further include a logic circuit comparing the signature MISR_SCAN_OUT output by the MISR 140 with a prestored signature.

The pattern generating circuit 110A according to one or more example embodiments may include a first pattern generating circuit 111, a second pattern generating circuit 112, a selection circuit 113, a pattern control circuit 114, and a bit information generating circuit 115.

The first pattern generating circuit 111 may generate a pseudo-random pattern. The first pattern generating circuit 111 may include a pseudo-random pattern generating circuit.

In one or more example embodiments, the first pattern generating circuit 111 may include a linear feedback shift register (LFSR) and a phase shifter.

The LFSR may generate a first bit pattern BP1 which is a pseudo-random pattern. For example, the LFSR may include a D flip-flop and an XOR gate and may be implemented with various known structures.

The phase shifter may remove the correlation of pseudo-random patterns generated by the LFSR. The phase shifter may generate a first bit pattern BP1 with the correlation removed.

In one or more example embodiments, the phase shifter may be implemented using various known circuits such as a structure configured to generate independent first bit patterns by performing an XOR operation on a plurality of pseudo-random patterns output by the LFSR, or a structure configured to shift bits at specific positions of a pseudo-random pattern to other positions.

The second pattern generating circuit 112 may generate a second bit pattern BP2. In one or more example embodiments, the second pattern generating circuit 112 may generate the second bit pattern BP2 using bit information BI and an output signal SCO_1, SCO_2 of at least one scan cell.

The bit information BI may be generated by the bit information generating circuit 115.

In one or more example embodiments, the bit information generating circuit 115 may generate bit information BI based on a bit period RPT in the first test mode.

In one or more example embodiments, the bit information generating circuit 115 may generate bit information BI based on a compressed pattern CP and a conversion table CT in the second test mode.

In one or more example embodiments, the processor 10A may generate at least a portion of the first test pattern TP1 using the second bit pattern BP2 in the first test mode. For example, in the first test mode, the second pattern generating circuit 112 may receive the output signal SCO_1 and SCO_2 of at least one scan cell and generate the first test pattern TP1 based on the output signal SCO_1 and SCO_2 of the scan cell.

In one or more example embodiments, the processor 10A may generate at least a portion of the second test pattern TP2 using the second bit pattern BP2 in the second test mode. For example, in the second test mode, the second pattern generating circuit 112 may receive the output signal SCO_1 and SCO_2 of at least one scan cell and generate the second test pattern TP2 based on the output signal SCO_1 and SCO_2 of the scan cell.

The selection circuit 113 may output either the first bit pattern BP1 or the second bit pattern BP2 based on a pattern control signal SEL generated by the pattern control circuit 114. The selection circuit 113 may output either the first bit pattern BP1 or the second bit pattern BP2 based on the sequential bit signals of the pattern control signal SEL.

For example, the selection circuit 113 may output the first bit pattern BP1 based on a first bit signal of the pattern control signal SEL at a first edge of a clock, and output the second bit pattern BP2 based on a second bit signal of the pattern control signal SEL at a second edge after the first edge.

The pattern generating circuit 110A may generate the test patterns TP1 and TP2 by combining the first bit pattern BP1 and the second bit pattern BP2.

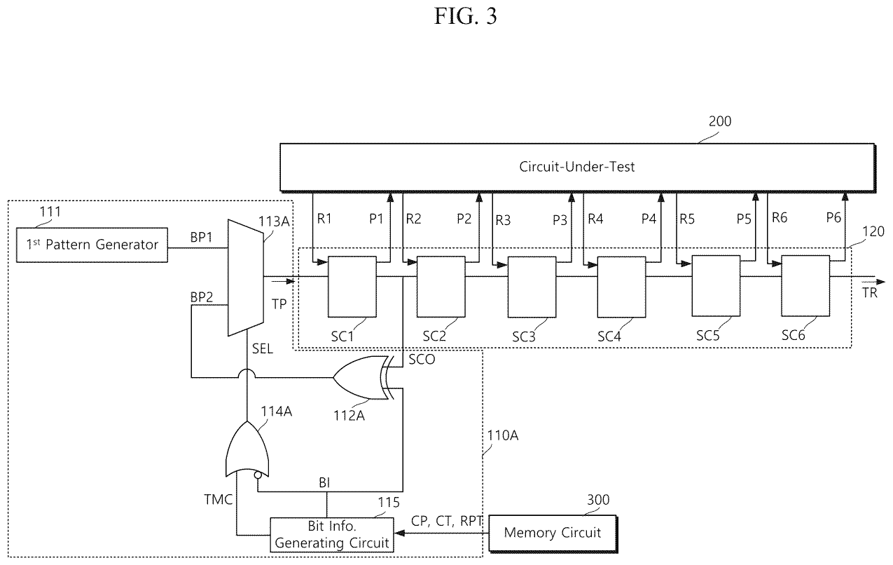

FIG. 3 is a diagram illustrating a pattern generating circuit according to one or more example embodiments.

The pattern generating circuit according to some example embodiments as seen in of FIG. 3 may correspond to the pattern generating circuit 110A of FIG. 2.

Referring to FIG. 3, the processor may include a pattern generating circuit 110A and a CUT 200.

The pattern generating circuit 110A may output a test pattern TP, and the test pattern TP may be scanned-in to the scan chain 120. For example, bits of the test pattern TP may sequentially shifted in to scan cells SC1, SC2, SC3, SC4, SC5, and SC6 connected in series to the inside of the scan chain 120.

The test pattern TP may be either the first test pattern TP1 or the second test pattern TP2 described with reference to FIG. 1 and FIG. 2. The pattern generating circuit 110A may generate the first test pattern TP1 in the first test mode and generate the second test pattern TP2 in the second test mode.

Referring to FIG. 3, the scan chain 120 may include a plurality of scan cells SC1, SC2, SC3, SC4, SC5, and SC6. In FIG. 3, the scan chain 120 is illustrated as including six scan cells SC1, SC2, SC3, SC4, SC5, and SC6, but the scan chain 120 may include a larger or smaller number of scan cells.

The test pattern TP, which has been scanned in (“scan-in”) to the scan chain 120, may be applied to the CUT 200.

Each of the scan cells SC1, SC2, SC3, SC4, SC5, and SC6 may apply a test pattern TP to each of the logic circuits of the coupled CUT 200. The test pattern TP may be the test patterns TP1 and TP2 described with reference to FIG. 1 and FIG. 2. For example, the scan cells SC1, SC2, SC3, SC4, SC5, and SC6 may output the bits P1, P2, P3, P4, P5, and P6 of the test pattern TP, respectively. The output bits P1, P2, P3, P4, P5, and P6 of the test pattern TP may be applied to the CUT 200.

The CUT 200 may perform a circuit operation based on the bits P1, P2, P3, P4, P5, and P6 of the test pattern TP, and may store responses R1, R2, R3, R4, R5, and R6 to the bits P1, P2, P3, P4, P5, and P6 of the test pattern TP in the scan cells SC1, SC2, SC3, SC4, SC5, and SC6.

Referring to FIG. 3, the pattern generating circuit 110A according to one or more example embodiments may include a first pattern generating circuit 111, a second pattern generating circuit 112A, a selection circuit 113A, a pattern control circuit 114A, and a bit information generating circuit 115.

The first pattern generating circuit 111 may generate a first bit pattern BP1. The first bit pattern BP1 may be a pseudo-random pattern.

The second pattern generating circuit 112A may generate a second bit pattern BP2. The second pattern generating circuit 112A may receive an output signal of any one of the plurality of scan cells and bit information BI and generate the second bit pattern BP2 based on the received signals. For example, the second pattern generating circuit 112A may output a result of an XOR operation on the output signal of one of the plurality of scan cells and the bit information BI as the second bit pattern BP2.

FIG. 3 illustrates an example in which the second pattern generating circuit 112A receives an output signal SCO of the first scan cell SC1 among the plurality of scan cells. However, the second pattern generating circuit 112A may receive an output signal of a scan cell, other than the first scan cell SC1, among the plurality of scan cells. Alternatively, the second pattern generating circuit 112A may receive output signals of a plurality of scan cells among the plurality of scan cells.

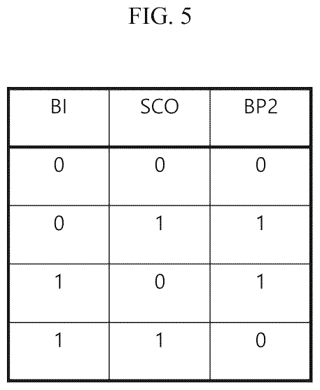

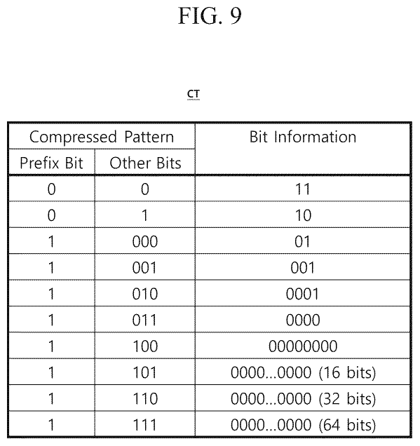

The bit information BI may be generated differently depending on the output signal of the scan cell received by the second pattern generating circuit 112A. For example, when the second pattern generating circuit 112A receives an output signal of a scan cell other than the first scan cell SC1, the bit information BI in the first test mode may be generated differently from FIG. 5, and the bit information BI in the second test mode may be generated based on a conversion table different from FIG. 9. A person of ordinary skill in the art may modify the bit information generating circuit 115 to generate different bit information BI depending on the output signal of the scan cell received by the second pattern generating circuit 112A with reference to one or more example embodiments.

The selection circuit 113A may select either the first bit pattern BP1 or the second bit pattern BP2 based on the pattern control signal SEL, and the selected signal may be output as the test pattern TP.

The selection circuit 113A may output the first bit pattern BP1 as some bits of the first test pattern and output the second bit pattern BP2 as other bits of the first test pattern. Alternatively, the selection circuit 113A may output only the second bit pattern BP2 as bits of the second test pattern. Therefore, at least one of the first test pattern and the second test pattern may include the second bit pattern BP2 based on the output signal of the scan cell.

The pattern control circuit 114A may output a pattern control signal SEL based on a test mode control signal TMC and the bit information BI. The pattern control circuit 114A may receive an inverted signal of the bit information BI. The test mode control signal TMC may be a signal indicating either the first test mode or the second test mode.

The bit information generating circuit 115 may generate bit information BI based on at least one of a compressed pattern CP, a conversion table CT, and a bit period RPT.

In one or more example embodiments, the bit information generating circuit 115 may output different bit information in the first test mode and the second test mode.

For example, the bit information generating circuit 115 may generate bit information BI based on a bit period RPT in the first test mode. The bit information generating circuit 115 may generate bit information BI based on a compressed pattern CP and a conversion table CT in the second test mode. In the second test mode, the bit information generating circuit 115 may generate bit information BI converted from a compressed pattern CP based on the conversion table CT.

The compressed pattern CP, the conversion table CT, and the bit period RPT may be prestored in a memory circuit 300.

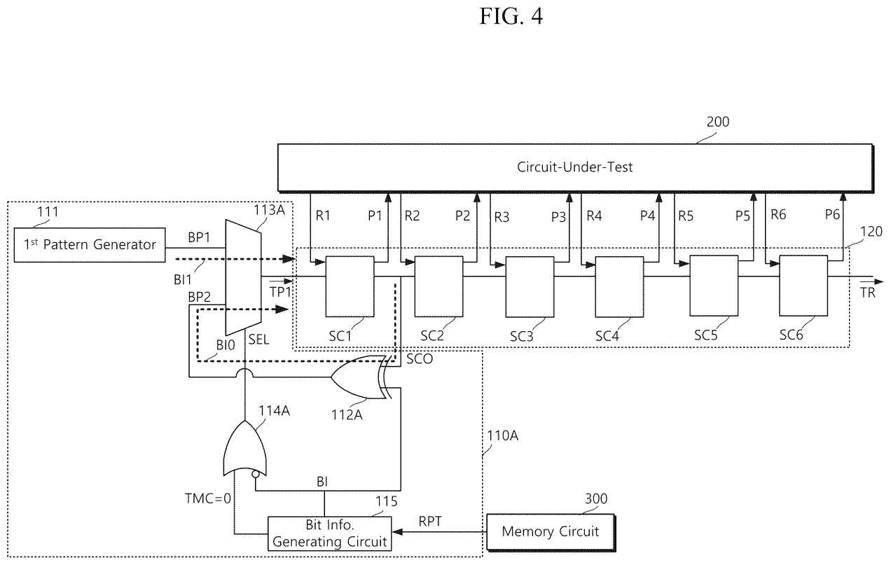

FIG. 4 is a diagram illustrating an operation of the pattern generating circuit 110A generating a first test pattern TP1 according to one or more example embodiments. Detailed descriptions overlapping with those described above with reference to FIG. 3 are omitted to avoid redundancy.

The selection circuit 113A may receive a test mode control signal (TMC=0) indicating the first test mode. The selection circuit 113A based on an OR gate may output a signal, identical to an inverted signal of the bit information BI, as a pattern control signal SEL.

The selection circuit 113A may receive a first bit pattern BP1 and a second bit pattern BP2. The first bit pattern BP1 may be a pseudo-random pattern generated by the first pattern generating circuit 111, and the second bit pattern BP2 may be a signal based on an output signal SCO of the first scan cell SC1 of the scan cell.

The selection circuit 113A may select either the first bit pattern BP1 or the second bit pattern BP2 based on the inverted signal of the bit information BI.

For example, when the bit information BI has a value of ‘1,’ the selection circuit 113A may output the first bit pattern BP1. In addition, when the bit information BI has a value of ‘0,’ the selection circuit 113A may output the second bit pattern BP2.

The second pattern generating circuit 112A may generate the second bit pattern BP2 based on the output signal SCO of the first scan cell SC1 and the bit information BI.

For example, the second pattern generating circuit 112A based on an XOR gate may operate as shown in FIG. 5. Referring to FIG. 5, when the bit information BI has a value of ‘0,’ the second pattern generating circuit 112A may output a second bit pattern BP2 having the same value as the output signal SCO of the first scan cell SC1.

Accordingly, when the bit information BI has a value of ‘0,’ a bit of the first test pattern TP1 input to the scan chain 120 at the current clock may have the same value as a bit of the first test pattern TP1 input to the scan chain 120 at a previous clock. For example, the bit of the first test pattern TP1 input to the scan chain 120 at the previous clock may be repeatedly input to the scan chain 120.

When the bit information BI has a value of ‘1,’ the selection circuit 113A may output the first bit pattern BP1.

As a result, some bits of the first test pattern TP1 input to the scan chain 120 in the first test mode may be based on the pseudo-random pattern of the first bit pattern BP1, while other bits may be a repetition of the bit of the first test pattern TP1 input to the scan chain 120 at the previous clock. A bit period, in which the bit of the first test pattern TP1 input to the scan chain 120 at the previous clock is repeated, may be controlled by the bit information BI. The bit information generating circuit 115 may generate the bit information BI based on a bit period RPT prestored in the memory circuit 300.

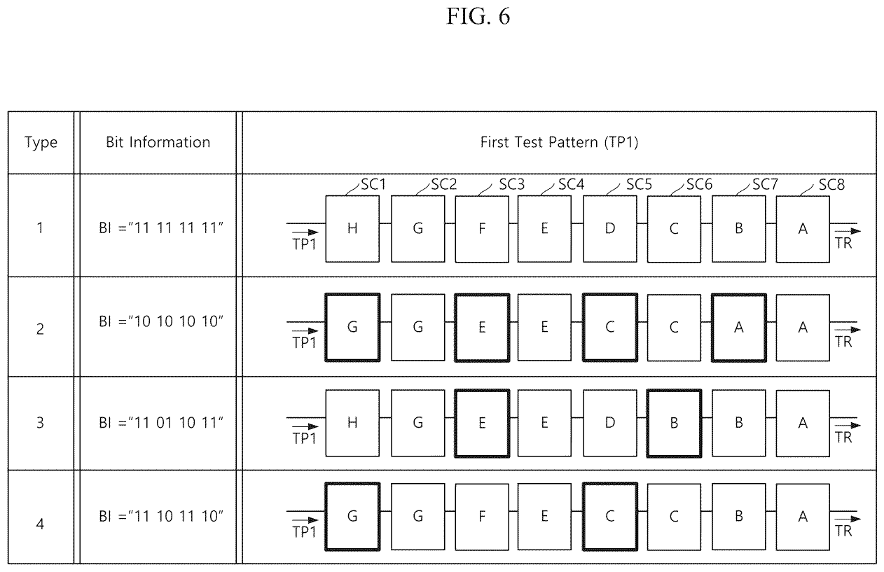

FIG. 6 is a diagram illustrating first test patterns TP1 according to one or more example embodiments. The first test pattern described with reference to FIG. 6 may correspond to the first test pattern TP1 of FIG. 4 when there are eight scan cells.

The first test pattern TP1 may have a plurality of types. FIG. 6 illustrates an example of four types of first test patterns TP1 having different bit periods in which the bits of the first test pattern TP1 are repeated. However, the first test pattern TP1 according to one or more example embodiments is not limited to the first test patterns TP1 of FIG. 6, and may employ first test patterns TP1 having different bit periods and bit repetition types from FIG. 6.

FIG. 6 illustrates an example of a first type of first test pattern TP1 having a bit period of 0, a second type of first test pattern TP1 having a bit period of 2, a third type of first test pattern TP1 having a bit period of 3, and a fourth type of first test pattern TP1 having a bit period of 4. The second type of first test pattern TP1, the third type of first test pattern TP1, and the fourth type of first test pattern TP1 may be referred to as modified pseudo-random patterns in the present specification.

When the bit period is k (k is an integer greater than or equal to 0), the second pattern generating circuit 112A of FIG. 4 may output a second bit pattern BP2 having the same value as the output signal of the scan cell every k bits. Accordingly, the first test pattern TP1 may include a bit identical to a previous bit every k bits.

Referring to FIG. 6, since the first type of first test pattern TP1 has a bit period of 0, it is identical to a pseudo-random pattern. The second type of first test pattern TP1 has a bit repeated every 2 bits that is identical to a previous bit. The second type of first test pattern TP1 may be generated based on bit information BI in which a bit string “10” is repeated. The third type of first test pattern TP1 has a bit repeated every 3 bits that is identical to a previous bit. The third type of first test pattern TP1 may be generated based on bit information BI in which a bit string “11 01 10” is repeated. The fourth type of first test pattern TP1 has a bit repeated every 4 bits that is identical to a previous bit. The fourth type of first test pattern TP1 may be generated based on bit information BI in which a bit string “11 10” is repeated.

In one or more example embodiments, the pattern generating circuit 110A of FIG. 4 may reset the bit period every desired (and/or alternatively predetermined) number of patterns. For example, when a desired (and/or alternatively predetermined) number of first test patterns TP1 are generated, the pattern generating circuit 110A may reset the bit period and generate the desired (and/or alternatively predetermined) number of first test patterns TP1 again based on the reset bit period.

For example, the pattern generating circuit 110A of FIG. 4 may generate a certain number of second types of first test patterns TP1, then generate a certain number of fourth types of first test patterns TP1, and then generate a certain number of first types of first test patterns TP1.

The number of patterns and the bit period applied to each pattern period may be prestored in the memory circuit 300 of FIG. 4.

In one or more example embodiments, the bit information generating circuit 115 of FIG. 4 may generate bit information BI based on a bit period RPT in the first test mode. For example, when the bit period RPT is 0, the bit information generating circuit 115 may generate bit information BI in which “11” is repeated. When the bit period RPT is 2, the bit information generating circuit 115 may generate bit information BI in which a bit string “10” is repeated. When the bit period RPT is 3, the bit information generating circuit 115 may generate bit information BI in which a bit string “11 01 10” is repeated. When the bit period RPT is 4, the bit information generating circuit 115 may generate bit information BI in which a bit string “11 10” is repeated.

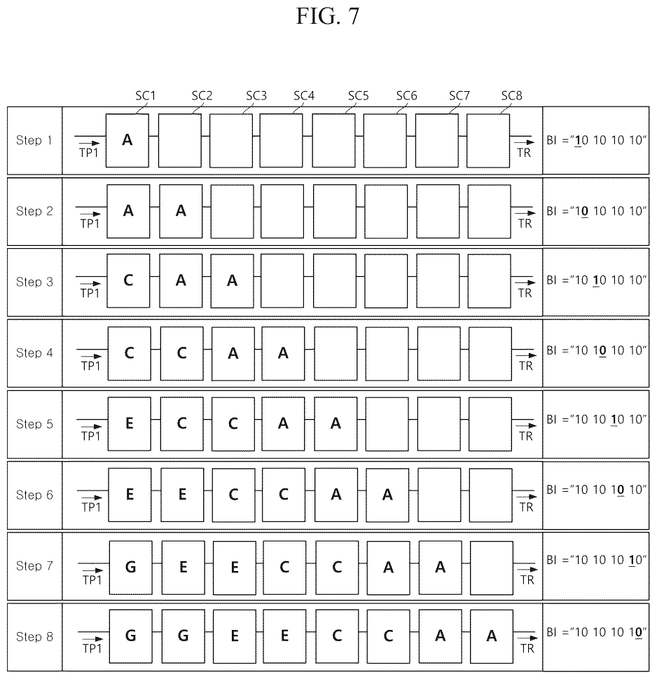

FIG. 7 is a diagram illustrating an operation in which a pattern generating circuit generates the second type of first test pattern TP1 of FIG. 6 according to one or more example embodiments. Each of “ACEG” stored in the scan cells in FIG. 7 is a bit having a value of “0” or “1”.

Referring to FIG. 7, the pattern generating circuit may generate the second type of first test pattern TP1 of FIG. 6 based on bit information BI in which a bit string “10” is repeated.

Referring to FIG. 7, the selection circuit 113A of FIG. 4 may output the first bit pattern BP1 of FIG. 4 based on each of the bits having a bit value of “1” among the bits of the bit information BI. For example, based on the first bit, the third bit, the fifth bit, and the seventh bit among the bits of the bit information BI, “A”, “C”, “E”, and “G” of the first bit pattern BP1 may be input to the first scan cell SC1 in a first step, a third step, a fifth step, and a seventh step, respectively.

Referring to FIG. 7, the selection circuit 113A of FIG. 4 may output the second bit pattern BP2 of FIG. 4 based on each of the bits having a bit value of “0” among the bits of the bit information BI. For example, based on the second bit, the fourth bit, the sixth bit, and the eighth bit among the bits of the bit information BI, the output signals “A”, “C”, “E”, and “G” of the first scan cell SC1 may be input to the first scan cell SC1 as the second bit pattern BP2 in a second step, a fourth step, a sixth step, and an eighth step, respectively.

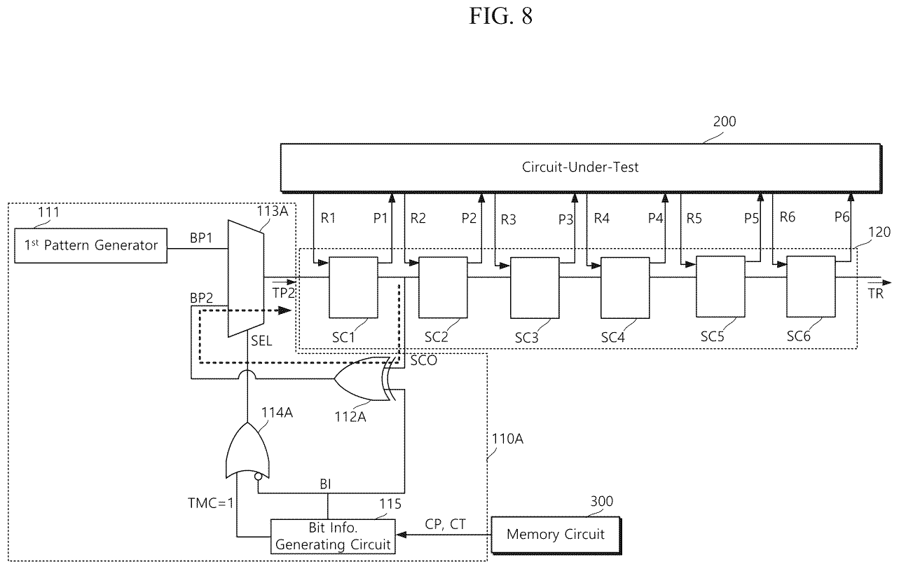

FIG. 8 is a diagram illustrating an operation of the pattern generating circuit 110A generating a second test pattern TP2 according to one or more example embodiments.

Detailed descriptions overlapping with those described above with reference to FIGS. 3 and 4 are omitted to avoid redundancy.

The selection circuit 113A may receive a test mode control signal (TMC=1) indicating the second test mode. Accordingly, the selection circuit 113A based on an OR gate outputs a “1” value as the control signal SEL, and the selection circuit 113A outputs the second bit pattern BP2. In the second test mode, the selection circuit 113A outputs the second bit pattern, not the first bit pattern BP1. That is, in the second test mode, the selection circuit 113A outputs only the second bit pattern BP2, not the first bit pattern BP1 of the pseudo-random pattern. The second bit pattern BP2 may be a bit pattern based on a deterministic pattern. This will be described below in greater detail.

The second pattern generating circuit 112A may generate the second bit pattern BP2 based on an output signal SCO of the first scan cell SC1 and the bit information BI.

For example, the second pattern generating circuit 112A based on an XOR gate may operate as shown in FIG. 5. Referring to FIG. 5, when the bit information BI has a value of ‘0,’ the second pattern generating circuit 112A may output a second bit pattern BP2 having the same value as the output signal SCO of the first scan cell SC1. When the bit information BI has a value of ‘1,’ the second pattern generating circuit 112A may output a second bit pattern BP2 having a value inverted from the output signal SCO of the first scan cell SC1.

Accordingly, when the bit information BI has a value of ‘0,’ a bit of the second test pattern TP2 input to the scan chain 120 at the current clock may have the same value as a bit of the second test pattern TP2 input to the scan chain 120 at a previous clock. Also, when the bit information BI has a value of ‘1,’ a bit of the second test pattern TP2 input to the scan chain 120 at the current clock may have an inverted value of a bit of the second test pattern TP2 input to the scan chain 120 at a previous clock.

The bit information generating circuit 115 may convert a compressed pattern CP into bit information BI based on a conversion table CT received from the memory circuit 300. The conversion table CT may include a correspondence relationship between the compressed pattern CP and the bit information BI. The compressed pattern CP may be a signal in which bit information BI generated based on a deterministic pattern is compressed based on the conversion table CT of FIG. 9.

Accordingly, the second test pattern TP2 may be generated based on a deterministic pattern. In one or more example embodiments, the bit information generating circuit 115 may convert the compressed pattern CP into bit information BI based on the conversion table CT of FIG. 9.

Faults of the CUT 200, undetectable by the first test pattern TP1 based on a pseudo-random pattern, may be detected based on the second test pattern TP2. As a result, the test coverage of the BIST circuit may be increased. Also, the compressed pattern of the deterministic pattern is stored in the memory circuit 300, so that the test coverage of the BIST circuit 100 may be improved with only a small increase in memory capacity.

FIG. 9 is a diagram illustrating a conversion table CT between a compressed pattern CP and bit information BI according to one or more example embodiments. The conversion table CT of FIG. 9 may correspond to the conversion table CT of FIG. 8. For example, the bit information generating circuit 115 of FIG. 8 may generate bit information BI using the conversion table CT of FIG. 9. The pattern generating circuit 110A of FIG. 8 may generate a second test pattern TP2 using the conversion table CT of FIG. 9. The conversion table CT of FIG. 9 will be described with reference to FIG. 8 and FIG. 9.

Referring to FIG. 9, a compressed pattern CP may include a first bit, which is a prefix bit, and other bits.

The prefix bit may indicate the size of the compressed pattern CP. The prefix bit may indicate the number of bits of the compressed pattern CP. For example, referring to FIG. 9, when the prefix bit is “0,” the compressed pattern CP may consist of two bits in total, including the prefix bit. When the prefix bit is “1,” the compressed pattern CP may consist of four bits in total, including the prefix bit.

The bit information generating circuit 115 of FIG. 8 may convert the compressed pattern CP with the number of bits indicated by the prefix bit into bit information BI based on the conversion table CT. For example, when data received from the memory circuit 300 is “011000”, the bit information generating circuit 115 may extract a first compressed pattern consisting of 2 bits from the data based on the first bit “0,” and extract a second compressed pattern consisting of 4 bits based on the third bit “1.” The bit information generating circuit 115 may then convert each of the first compressed pattern and the second compressed pattern into bit information BI based on the conversion table CT.

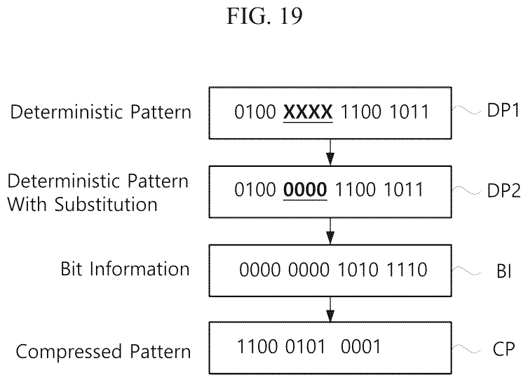

Referring to FIG. 9, it can be seen that a portion of the bit information BI does not reduce the pattern size even when converted into a compressed pattern CP, but another portion of the bit information BI significantly reduces the pattern size when converted into a compressed pattern CP. For example, when the bit information BI includes a bit string in which a bit value “0” is consecutive, the bit information BI may be compressed with a high compressing ratio. In view of this characteristic, the bit information BI may be generated based on a consecutive bit string of a deterministic pattern. For example, the bit information BI may be generated based on a run length. For example, when a bit to be converted in the deterministic pattern has the same bit value as the previous bit, the bit may be converted into a “0” bit of the bit information BI. This will be described in detail below with reference to FIG. 19.

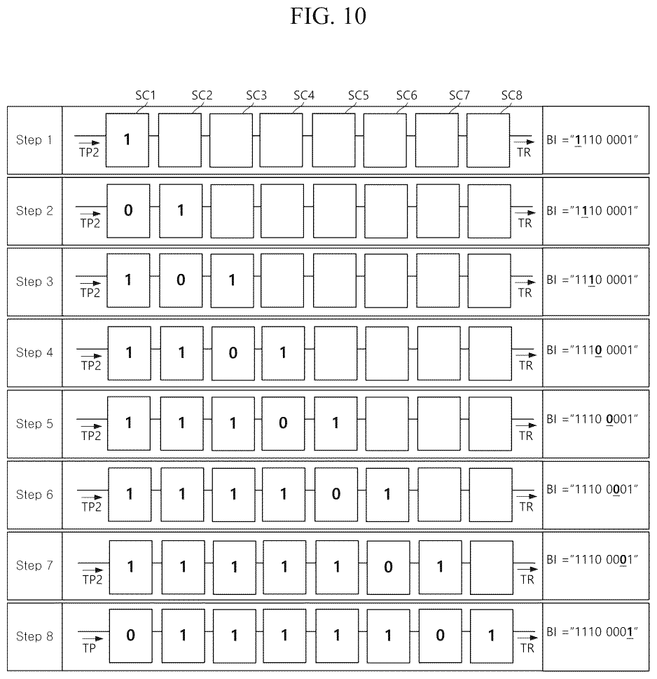

FIG. 10 is a diagram illustrating an operation in which a pattern generating circuit according to one or more example embodiments generates a second test pattern based on bit information BI. The operation in FIG. 10 may be performed by the pattern generating circuit 110A of FIG. 8.

Referring to FIG. 10, the pattern generating circuit 110A may generate a second bit pattern BP2 based on each of the bits of the bit information BI, and the second bit pattern BP2 may be input to the scan chain as a second test pattern TP2.

The pattern generating circuit 110A may generate the same value as an output signal of the first scan cell SC1 as the second bit pattern BP2 based on each of the bits having a bit value of “0” among the bits of the bit information BI. The pattern generating circuit 110A may generate a value inverted from an output signal of the first scan cell SC1 as the second bit pattern BP2 based on each of the bits having a bit value of “1” among the bits of the bit information BI.

Referring to FIG. 10, in Step 1, a result of an XOR operation on the first bit “1” of the bit information BI and an initial set bit “0” of the first scan cell, which is “1,” is input to the first scan cell SC1.

In Step 2, a result of an XOR operation on the second bit “1” of the bit information BI and the output signal “1” of the first scan cell, which is “0,” is input to the first scan cell SC1. For example, “0”, which is an inverted value of the output signal “1” of the first scan cell, is input to the first scan cell SC1.

In Step 3, a value of “1”, which is an inverted value of the output signal “0” of the first scan cell, is input to the first scan cell SC1 based on the third bit “1” of the bit information BI, similarly to Step 2.

In Step 4, a value of “1,” which is the same value as the output signal “1” of the first scan cell, is input to the first scan cell SC1 based on the fourth bit “0” of the bit information BI.

In Steps 5 to 8, the pattern generating circuit 110A generates the second test pattern TP2 based on the bit information BI and the output signal of the first scan cell SC1 until all the scan cells SC1 to SC8 of the scan cell are scanned in.

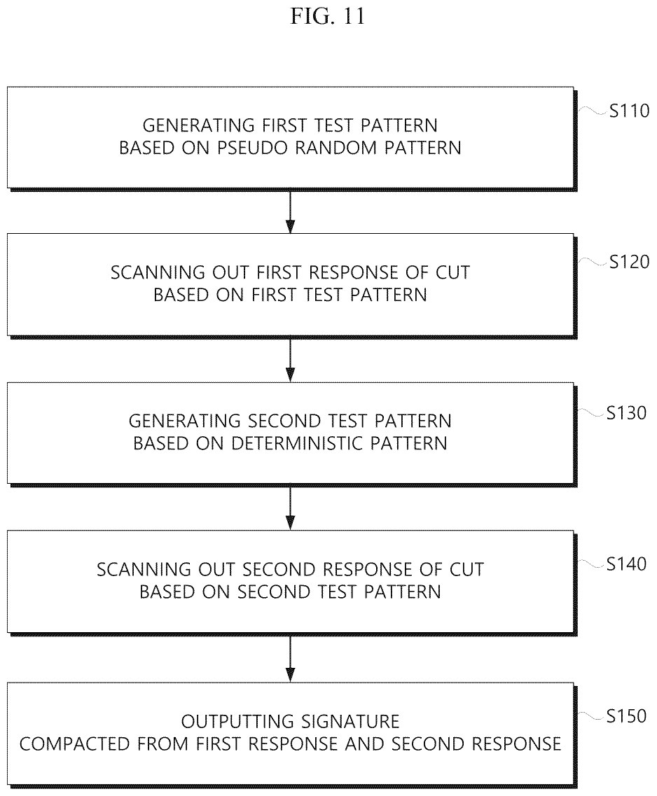

FIG. 11 is a flowchart illustrating a method of operating a processor according to one or more example embodiments. The method of FIG. 11 may be performed in the processors 10 and 10A of FIG. 1 and FIG. 2. The method of operating the processor will be described with reference to FIG. 11. Detailed descriptions overlapping with those described above with reference to FIGS. 1-10 are omitted to avoid redundancy.

Referring to FIG. 11, the processor may generate a first test pattern based on a pseudo-random pattern in operation S110. The processor may generate a first test pattern based on the first bit pattern BP1 and the second bit pattern BP2 described with reference to FIG. 4. The first bit pattern BP1 is a pseudo-random pattern, and the second bit pattern BP2 may be based on an input signal input to the scan chain at a previous clock. For example, the second bit pattern BP2 may be an output signal of at least one of the scan cells of the scan chain.

In one or more example embodiments, the first test pattern may be a test pattern of any one type among a plurality of types of test patterns described with reference to FIG. 6. The first test pattern of the present example embodiments is not limited to the types of test patterns of FIG. 6.

In operation S120, the processor may scan out a first test response of the CUT based on the first test pattern.

In operation S130, the processor may generate a second test pattern based on a deterministic pattern. The processor may generate the second test pattern based on the second bit pattern BP2 described with reference to FIG. 8. The second bit pattern BP2 may be a bit identical to an input signal input to the scan chain at a previous clock or an inverted bit of the input signal input to the scan chain at a previous clock, based on bit information BI. For example, the second bit pattern BP2 may have the same value as or an inverted value of an output signal of at least one of the scan cells of the scan chain.

In operation S140, the processor may scan out a second test response of the CUT based on the second test pattern.

In operation S150, the processor may output a signature in which the first test response and the second test response are compacted.

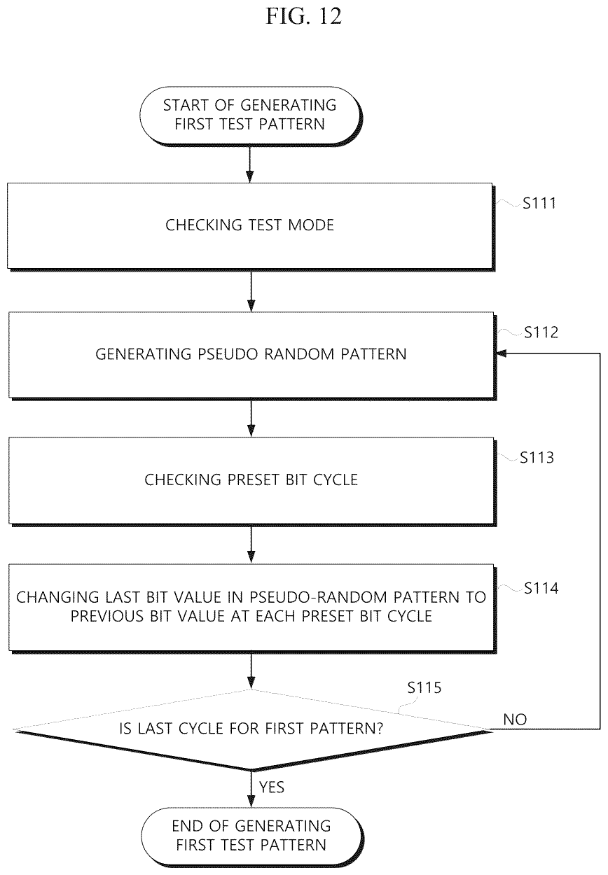

FIG. 12 is a flowchart illustrating an operation in which a processor generates a first test pattern according to one or more example embodiments. The operation of FIG. 12 may be performed by the pattern generating circuit 110A of FIG. 4. Detailed descriptions overlapping with those described above with reference to FIGS. 4-7 are omitted to avoid redundancy.

In operation S111, the pattern generating circuit 110A may check the test mode.

When the test mode is the first test mode indicating the generation of the first test pattern TP1 of FIG. 4, the processor may generate a pseudo-random pattern in operation S112.

In operation S113, the processor checks a desired (and/or alternatively predetermined) bit period. In operation S114, the processor may generate the first test pattern TP1 by changing a last bit value to a previous bit value every desired (and/or alternatively predetermined) bit period in the pseudo-random pattern. For example, the processor may generate the first test pattern TP1 as illustrated in FIG. 6 based on the bit period.

In operation S115, the processor checks a pattern period. When the pattern period is a last pattern period for the first test pattern TP1, the processor may terminate the generation of the first test pattern TP1. When the pattern period is not the last pattern period, operations S112 to S114 may be repeated. Bit periods used for each pattern period may be different from each other. A bit period corresponding to each pattern period may be prestored in the memory circuit.

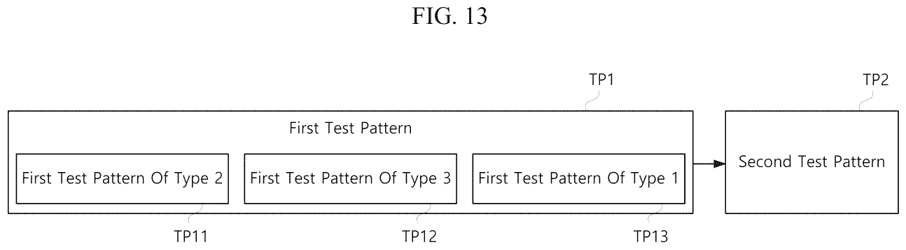

FIG. 13 is a diagram illustrating an operation in which a processor generates a first test pattern according to one or more example embodiments.

The processor may generate a desired (and/or alternatively predetermined) number of first test patterns TP1 in each of a plurality of pattern periods. FIG. 13 illustrates an example in which the processor generates a first test pattern TP1 in each of three pattern periods.

For example, referring to FIG. 13, the processor may generate a desired (and/or alternatively predetermined) number of second types of first test patterns TP1 in a first pattern period, a desired (and/or alternatively predetermined) number of third types of first test patterns TP1 in a second pattern period, and a desired (and/or alternatively predetermined) number of first types of first test patterns TP1 in a third pattern period.

The type of first phase data PDT1 to be generated in each pattern period may be prestored in the memory circuit. For example, a bit period RPT corresponding to the type of first test pattern TP1 to be generated in each pattern period may be prestored in the memory circuit.

After completing the generation of the first test pattern TP1 in each of the plurality of pattern periods, the processor may generate a second test pattern TP2.

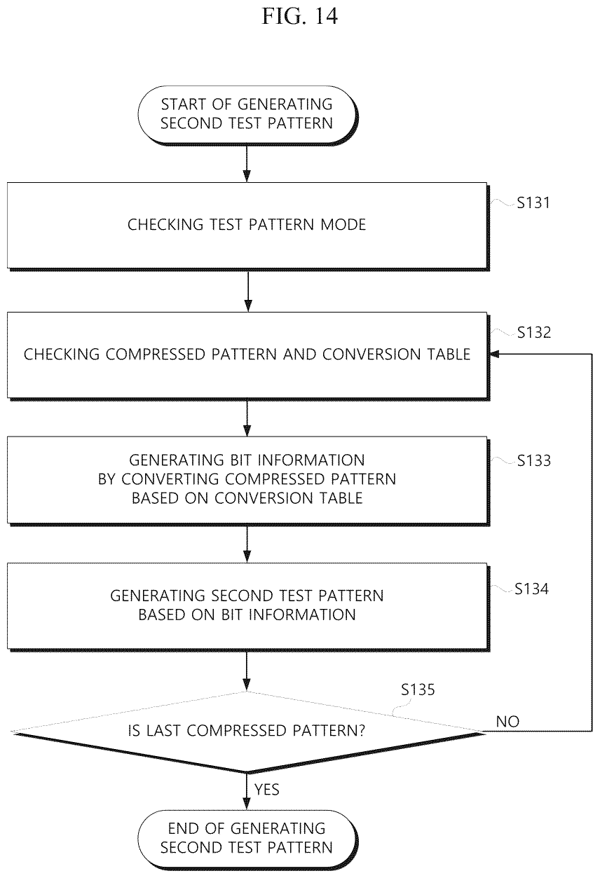

FIG. 14 is a flowchart illustrating an operation in which a processor generates a second test pattern according to one or more example embodiments. The operation of FIG. 14 may be performed by the pattern generating circuit 110A of FIG. 8. Detailed descriptions overlapping with those described above with reference to FIGS. 8-10 are omitted to avoid redundancy.

In operation S131, the pattern generating circuit 110A may check the test mode.

When the test mode is the second test mode indicating the generation of the second test pattern TP2 of FIG. 4, the processor may check a pre-stored compressed pattern and a conversion table in operation S132. For example, the processor may receive a compressed pattern and a conversion table from the memory circuit. For example, the processor may check a prefix bit of the compressed pattern and extract a compressed pattern to be converted from data received from the memory circuit.

In operation S133, the processor may convert the compressed pattern based on the conversion table to generate bit information. For example, the processor may convert the compressed pattern into bit information based on the conversion table of FIG. 9.

In operation S134, the processor may generate a second test pattern TP2 based on the bit information. For example, the processor may generate the second test pattern TP2 based on the bit information as illustrated in FIG. 10.

In operation S135, the processor checks whether the compressed pattern received from the memory circuit is a last compressed pattern. When there are remaining compressed patterns, the processor may repeat operations S132 to S134. When the compressed pattern received from the memory circuit is the last compressed pattern, the processor may terminate the generation of the second test pattern TP2.

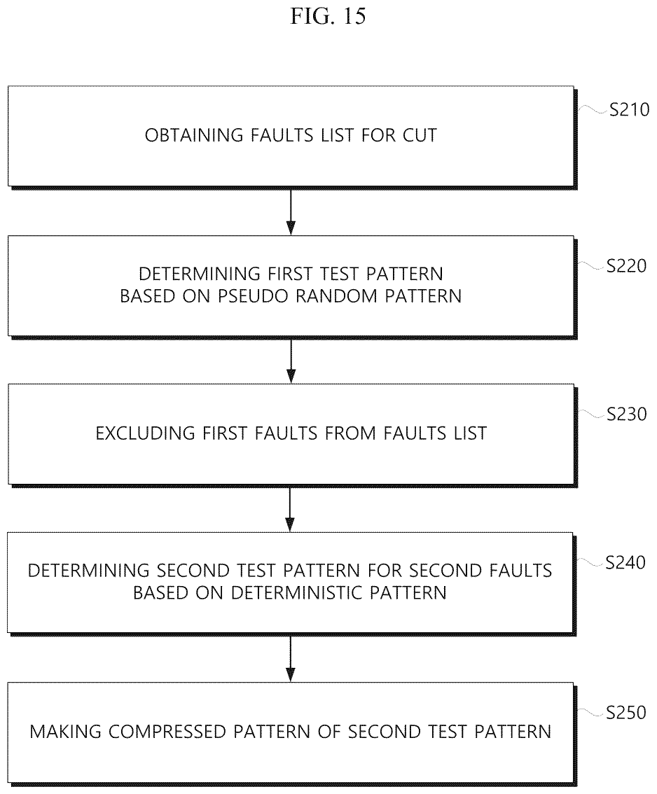

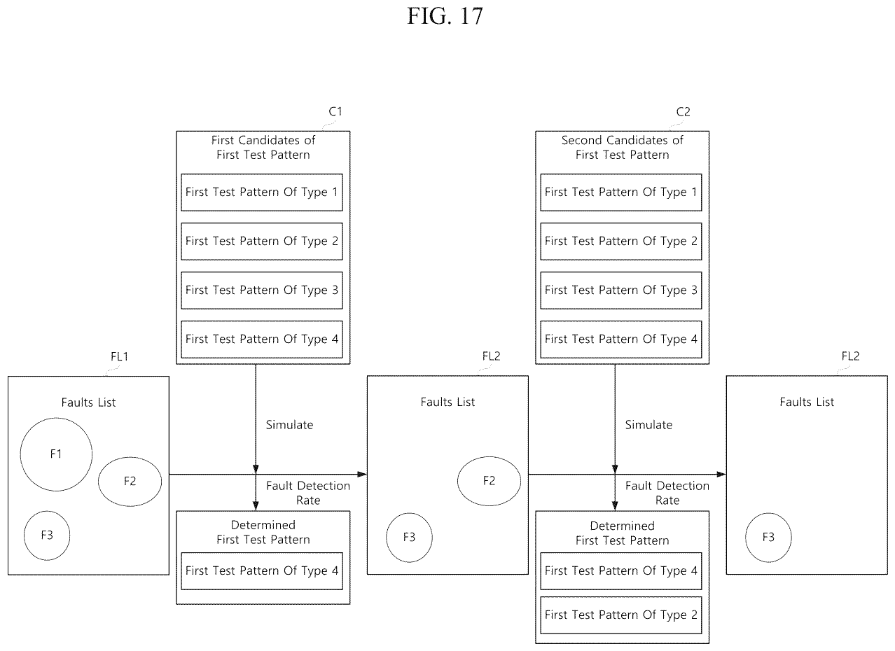

FIG. 15 is a flowchart illustrating a method of manufacturing a processor according to one or more example embodiments. The method of FIG. 15 may be used for manufacturing the processors 10 and 10A of FIG. 1 and FIG. 2. The method of FIG. 15 may be performed in a test apparatus of the processor. The test apparatus may be semiconductor automatic test equipment and may include an automatic test pattern generator (ATPG) or cooperate with an ATPG to perform the method of FIG. 15. The method of manufacturing a processor will be described with reference to FIGS. 15 and 17.

In operation S210, the test apparatus may acquire a fault list of the CUT. In one or more example embodiments, the fault list may be response bits determined to be faults of the CUT.

In FIG. 17, a first fault list is illustrated as including three partial fault lists F1, F2, and F3. The three partial fault lists F1, F2, and F3 of the first fault list are conceptually illustrated for the purpose of description, and do not mean that the first fault list is pre-divided into three partial fault lists F1, F2, and F3 and then stored.

In operation S220, the test apparatus may determine a first test pattern based on a pseudo-random pattern that detects the faults in the first fault list. For example, the test apparatus may generate a plurality of different types of test patterns of FIG. 6 and determine a first test pattern that detects the faults in the first fault list among the generated test patterns. The first test pattern may include a modified pseudo-random pattern in which a last bit value is changed to a previous bit value every desired (and/or alternatively predetermined) bit period among a plurality of bits of the pseudo-random pattern.

Operation S220 may be performed a plurality of times. For example, the test apparatus may determine one type of test pattern that detects the most faults among the plurality of types of test patterns of FIG. 6 as a (1-1)-th test pattern. Then, the test apparatus may generate the plurality of types of test patterns of FIG. 6 again and determine one type of test pattern that detects the most faults among the faults from which faults detectable by the (1-1)-th test pattern are excluded as a (1-2)-th test pattern. The test apparatus may determine the (1-1)-th test pattern and the (1-2)-th test pattern as the first test pattern. The test apparatus may store the bit period corresponding to each of the first-1 test pattern and the first-2 test pattern in the memory circuit in order.

In operation S230, the test apparatus may exclude first faults corresponding to the first test pattern from the fault list. For example, the test apparatus may exclude a first partial fault list F1 and a second fault list F2 corresponding to the first test pattern from the first fault list of FIG. 17.

In operation S240, the test apparatus may determine a second test pattern based on a deterministic pattern. For example, the test apparatus may use an ATPG to generate deterministic patterns that detect the faults F3 from which the first partial fault list F1 and the second fault list F2 corresponding to the first test pattern are excluded in the first fault list of FIG. 17. The test apparatus may determine the deterministic patterns as the second test patterns.

In operation S250, the test apparatus may generate compressed patterns based on the second test patterns. For example, the test apparatus may convert each of the second test patterns into bit information and convert each of the converted bit information into compressed patterns based on a conversion table. The test apparatus may store the compressed patterns and the conversion table in the memory circuit. A method in which the test apparatus converts a deterministic pattern into bit information and converts the bit information into a compressed pattern will be described in greater detail below with reference to FIG. 19.

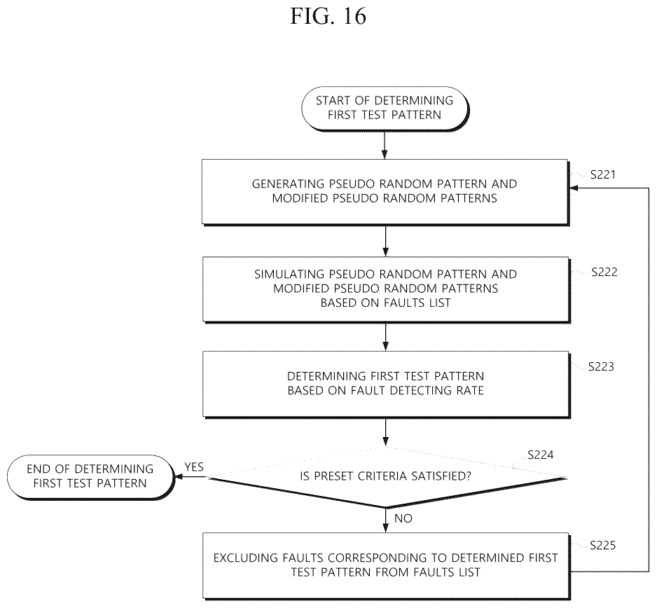

FIG. 16 is a flowchart illustrating a method of determining a first test pattern, in the method of manufacturing a processor according to one or more example embodiments. The method of FIG. 16 may be performed by the test apparatus as part of operation S220 of FIG. 15. A method in which the test apparatus determines a first test pattern will be described with reference to FIG. 16 and FIG. 17.

Referring to FIG. 16 and FIG. 17, in operation S221, the test apparatus may generate first candidate patterns C1 including a pseudo-random pattern and a modified pseudo-random pattern as illustrated in FIG. 6.

In operation S222, the test apparatus may simulate the first candidate patterns C1 including the pseudo-random pattern and the modified pseudo-random pattern based on a first fault list FL1 that includes pre-identified faults.

For example, the test apparatus may generate a desired (and/or alternatively predetermined) number of pseudo-random patterns and modified pseudo-random patterns, respectively, and check whether each of the generated patterns detects at least one of the faults in the first fault list FL1.

In operation S223, the test apparatus may determine a first test pattern from the first candidate patterns C1 based on a fault detection rate of the pseudo-random pattern and the modified pseudo-random pattern.

For example, the test apparatus may determine a type that detects the most faults in the first fault list FL1 among the desired (and/or alternatively predetermined) number of generated pseudo-random patterns and modified pseudo-random patterns. Referring to FIG. 17, the result of a first simulation shows that the fourth type of modified pseudo-random patterns were determined as the first test pattern because they detect the most faults in the first fault list FL1.

In operation S224, the test apparatus may check whether a desired (and/or alternatively predetermined) generation termination criterion for the first test pattern is satisfied. When the termination criterion is not satisfied, the test apparatus may exclude the faults for which detection has been completed from the fault list in operation S225 and repeats operations S221 to S224.

For example, referring to FIG. 17, the test apparatus may generate second candidate patterns C2 including a pseudo-random pattern and a modified pseudo-random pattern and perform a simulation again based on a fault list FL2 from which the first partial fault list F1 is excluded. Referring to FIG. 17, the result of a second simulation shows that that the second type of modified pseudo-random patterns are additionally determined as the first test pattern because they detect the most faults in the second fault list FL2.

The generation termination criterion for the first test pattern may be desired (and/or alternatively predetermined) in various ways. According to some example embodiments, the generation termination criterion for the first test pattern is not limited to a specific method.

In one or more example embodiments, the generation termination criterion for the first test pattern may be based on the number of deterministic patterns. For example, first test patterns may be added until the number of deterministic patterns that detect the remaining faults after the first test pattern is determined reaches a desired (and/or alternatively predetermined) criterion.

In one or more example embodiments, the generation termination criterion for the first test pattern may be based on a reduction rate of the number of deterministic patterns. For example, the number of deterministic patterns that detect the remaining faults may decrease each time a first test pattern is added. When the reduction rate of the deterministic patterns falls below a desired (and/or alternatively predetermined) ratio or the change in the reduction rate becomes small despite the addition of a first test pattern, the test apparatus may terminate the generation of the first test pattern.

In one or more example embodiments, the generation termination criterion for the first test pattern may be based on the storage capacity of the memory circuit. For example, when the reduction rate of the storage space in which compressed patterns based on the deterministic patterns are stored falls below a desired (and/or alternatively predetermined) ratio or the change in the reduction rate becomes small in spite of the addition of a first test pattern, the test apparatus may terminate the generation of the first test pattern.

When the termination of the first test pattern is completed, the test apparatus may determine a second test pattern based on a fault list that excludes faults detectable by the first test pattern.

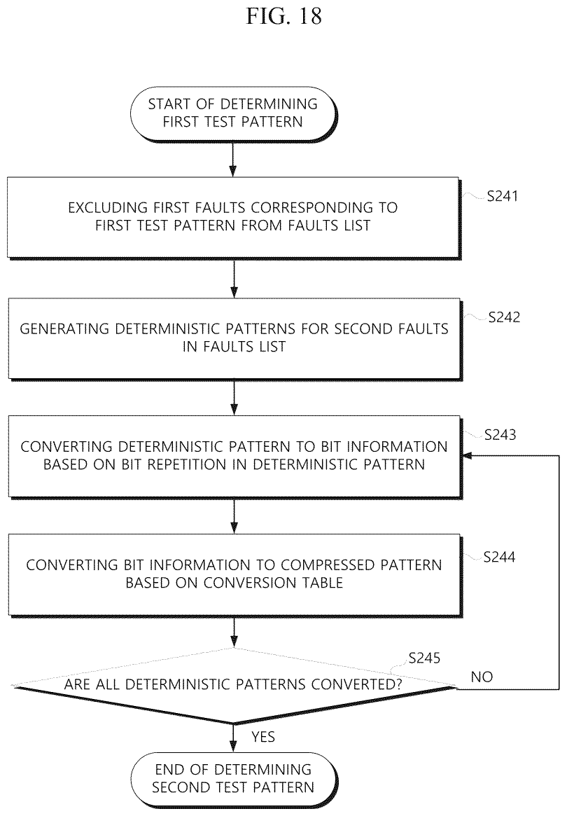

FIG. 18 is a flowchart illustrating a method of determining a second test pattern, in the method of manufacturing a processor according to one or more example embodiments. The method of FIG. 18 may be performed by the test apparatus as a portion of operation S240 of FIG. 15. A method in which the test apparatus determines a second test pattern will be described with reference to FIG. 18 and FIG. 19.

Referring to FIG. 18, in operation S241, the test apparatus may remove first faults corresponding to the first test pattern from the fault list.

In operation S242, the test apparatus may generate second test patterns which are deterministic patterns that detect second faults, which are the remaining faults from which the first faults have been removed from the fault list.

For example, referring to FIG. 19, a first pattern DP1 with bit values of “0100 XXXX 1100 1011” corresponding to the second faults may be generated by an automatic test pattern generator (ATPG). The first pattern DP1 may include Don't Care bits “XXXX.”

The test apparatus may generate a second pattern DP2 by substituting the Don't Care bits “XXXX” of the first pattern DP1 with a bit “0” or a bit “1.”

In one or more example embodiments, the test apparatus may substitute the Don't Care bits with a bit “0” or a bit “1” to significantly increase the length of the bit string in which identical bit values are consecutive.

For example, when both bits on opposite sides of the Don't Care bits in the deterministic pattern are bit “0,” the test apparatus may substitute the Don't Care bits with a bit “0.” When both bits on the opposite sides of the Don't Care bits in the deterministic pattern are bit “1,” the test apparatus may substitute the Don't Care bits with a bit “1.” When the bits on opposite sides of the Don't Care bits in the deterministic pattern are a bit “0” and a bit “1,” respectively, the test apparatus may substitute each of the Don't Care bits with a bit “0” or a bit “1” and substitute the Don't Care bits to significantly increase the length of the bit string in which identical bit values are consecutive.

Referring to FIG. 19, in the first pattern DP1, when the bits on the opposite sides of the Don't Care bits “XXXX” are respectively bit “0” and bit “1,” substituting replacing the Don't Care bits with either “0000” or “1111” results in the same bit string length of consecutive identical bits. In both cases, the length of the consecutive identical bits is six. Accordingly, FIG. 19 illustrates the case in which the Don't Care bits “XXXX” are substituted with “0000.”

In operation S243, the test apparatus may convert the second pattern DP2 with the Don't Care bits substituted into bit information based on whether the bit values of the second test pattern are repeated.

The test apparatus may generate a first bit of the bit information BI identical to a first bit of the second pattern DP2 and generate subsequent bits of the bit information BI based on whether each corresponding bit of the second pattern DP2 has the same bit value as a previous bit.

For example, referring to FIG. 19, since the second bit “0” of the second pattern DP2 has the same value as the first bit, the test apparatus may set the second bit of the bit information BI to “0.” The bits of the second pattern DP2 continue to have the same value as the previous bit up to the eighth bit, so that the test apparatus may set the bits of the bit information BI from the third bit to the eighth bit to “0.” The ninth bit of the second pattern DP2 changes to “1” unlike the previous bit, so that the test apparatus may set the ninth bit of the bit information BI to “1.” The tenth bit of the second pattern DP2 is a bit “1” which is again the same as the previous bit, so that the test apparatus may set the tenth bit of the bit information BI to “0.” Then, the test apparatus repeats the same operations up to the last bit of the second pattern DP2.

In operation S244, the test apparatus may convert the bit information into a compressed pattern based on a desired (and/or alternatively predetermined) correspondence relationship. For example, the test apparatus may convert the bit information into a compressed pattern based on the conversion table CT of FIG. 9.

For example, referring to FIG. 9 and FIG. 19, the test apparatus may search for a bit string corresponding to the longest bit information in the conversion table CT from the bit information BI. For example, the test apparatus may search a corresponding bit string from the beginning of the bit information BI from a lowest bit string in an upward direction in FIG. 9.

A bit string “0000 0000” consisting of the first to eighth bits of the bit information BI in FIG. 19 corresponds to a compressed pattern CP “1100” in the conversion table CT of FIG. 9, so that the test apparatus may convert the bit string “0000 0000” of the bit information BI into the compressed pattern CP “1100.” A it string “10” consisting of the ninth to tenth bits of the bit information BI corresponds to a compacted pattern CP “01” in the conversion table CT of FIG. 9, so that the test apparatus may convert the bit string “10” of the bit information BI into the compressed pattern CP “01.” The bit string “10” consisting of the eleventh and twelfth bits of the bit information BI is the same as the previous one, so that the test apparatus may convert the bit string “10” of the bit information BI into the compressed pattern CP “01.” Similarly, the remaining bit strings “11” and “10” of the bit information BI may be converted into “00” and “01” of the compacted pattern CP, respectively.

The remaining bit strings in the bit information BI that do not correspond to the conversion table CT may be a bit string in which multiple “0” bits are consecutive. The test apparatus may generate bits of the compressed pattern consisting of a multiple of 4 bits by padding multiple “0” bits to the remaining bit strings. For example, when the remaining bits of the bit information are “000,” “0000” may be stored in the compressed pattern. When “0000” is actually input to a scan chain, a pattern data input signal may be generated as long as the length of the scan chain. As a result, only the upper 3 bits may be used.

As set forth above, according to some example embodiments, the test coverage of a built-in self-test (BIST) circuit may be improved using a significantly reduced memory space.

According to some example embodiments, the test coverage of a BIST circuit may be improved by modifying pseudo-random patterns.

According to some example embodiments, the reliability of a processor may be improved.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While various example embodiments have been shown and described above, it will be apparent to those skilled in the art that modifications and variations could be made without departing from the scope of the present inventive concepts as defined by the appended claims.

What is claimed is:

1. A processor comprising:
a scan chain including a plurality of scan cells connected in a chain,
the scan chain configured to
scan-in an input signal sequentially to the plurality of scan cells,
store the input signal as a test pattern, and
scan-out a test response from a circuit-under-test based on the test pattern;
a pattern generating circuit configured to
generate a first test pattern based on a pseudo-random pattern,
generate a second test pattern based on a deterministic pattern, and
transmit the first test pattern and the second test pattern to the scan chain;
the circuit-under-test comprising a logic circuit coupled to the plurality of scan cells; and
a compacting circuit configured to output a signature by compacting the test response of the circuit-under-test,
wherein the pattern generating circuit is further configured to generate at least a portion of the first test pattern and the second test pattern based on an output signal of at least one scan cell of the plurality of scan cells.

2. The processor of claim 1, wherein
the pattern generating circuit comprises
a first pattern generating circuit configured to output a first bit pattern, the first bit pattern being a pseudo-random pattern,
a bit information generation circuit configured to output different types of bit information in a first test mode and a second test mode,
a second pattern generating circuit (XOR) configured to output a second bit pattern based on the bit information and the output signal of the at least one scan cell of the plurality of scan cells, and
a selection circuit configured to
select at least one of the first bit pattern and the second bit pattern based on a pattern control signal, and
transmit the selected bit pattern to the scan chain, and
at least one of the first test pattern and the second test pattern comprises the second bit pattern.

3. The processor of claim 2, wherein
the second pattern generating circuit comprises an XOR gate configured to
receive an output of a first scan cell of the plurality of scan cells and the bit information, and
output the second bit pattern.

4. The processor of claim 2, further comprising:
a pattern control circuit configured to generate the pattern control signal based on a test mode control signal and the bit information,
wherein the test mode control signal selects one of the first test mode and the second test mode.

5. The processor of claim 2, wherein
the bit information generation circuit is configured to
output the bit information from the first test mode, the first test mode configured to repeat a bit sequence, and
output the bit information from the second test mode, the second test mode configured to compress the deterministic pattern and convert the compressed pattern.

6. The processor of claim 5, wherein the bit information generation circuit is configured to determine a number of bits (n-bits) of the compressed pattern based on a first bit of the compressed pattern.

7. The processor of claim 6, further comprising:
a memory circuit configured to store the compressed pattern and a correspondence relationship, the correspondence relationship being a relationship between the compressed pattern and the bit information.

8. The processor of claim 7, wherein
the bit information generation circuit is configured to receive the compressed pattern from the memory circuit based on the n-bits of the compressed pattern, and
generate the bit information by converting the compressed pattern based on the correspondence relationship.

9. The processor of claim 2, wherein the pattern generating circuit is configured to output the output signal of the at least one scan cell of the plurality of scan cells every n-bits in the first test mode.

10. The processor of claim 9, wherein the pattern generating circuit is configured to output the output signal of the at least one scan cell of the plurality of scan cells based on the bit information including a repeating bit sequence.

11. The processor of claim 9, wherein the pattern generating circuit is configured to reset the n-bits based on a set number of test patterns.

12. The processor of claim 2, wherein the pattern generating circuit is configured to generate the second test pattern by inverting the output signal of the at least one scan cell of the plurality of scan cells based on bit information in the second test mode.

13. A method of operating a processor, the method comprising:
generating a first test pattern based on a pseudo-random pattern;
scanning-out a first test response of a circuit-under-test based on the first test pattern;
generating a second test pattern based on a deterministic pattern;
scanning-out a second test response of the circuit-under-test based on the second test pattern; and
outputting a signature by compacting the first test response and the second test response,
wherein at least a portion of the first test pattern and the second test pattern is based on an input signal input to a scan chain in a previous clock cycle.

14. The method of claim 13, wherein
generating the pseudo-random pattern includes changing a last bit value to a previous bit value in the pseudo-random pattern every bit period.

15. The method of claim 14, wherein
the changing of the last bit value to the previous bit value comprises changing the last bit value to the previous bit value based on bit information, and
the bit information is a bit signal including a repeating bit sequence.

16. The method of claim 13, wherein
the generating the second test pattern comprises
generating bit information by code-converting a compressed pattern, the compressed pattern including a compressed deterministic pattern, and
generating the second test pattern based on the bit information; and
the compressed pattern and a correspondence relationship are prestored in a memory circuit, the correspondence relationship being a relationship between the compressed pattern and the bit information.

17. A method of manufacturing a processor, the method comprising:
obtaining a fault list of a circuit-under-test;
determining a first test pattern based on a pseudo-random pattern for detecting first faults in the fault list;
detecting at least a portion of second faults and determining a second test pattern based on a deterministic pattern, the second faults including faults corresponding to the first test pattern and excluding the first faults; and
storing information of the first test pattern and a compressed pattern of the second test pattern in a memory circuit,
wherein the first test pattern comprises a modified pseudo-random pattern, the modified pseudo-random pattern including a last bit value among a plurality of bits of the pseudo-random pattern, the last bit value being configured to change to a previous bit value every bit period.

18. The method of claim 17, wherein
the determining the first test pattern comprises
generating the pseudo-random pattern and the modified pseudo-random pattern,
simulating the pseudo-random pattern and the modified pseudo-random pattern based on the fault list, and
determining the first test pattern based on fault detection rates of the pseudo-random pattern and the modified pseudo-random pattern.

19. The method of claim 18, wherein
the generating the modified pseudo-random pattern comprises generating a plurality of types of modified pseudo-random patterns, and
the generating each type of the plurality of types of modified pseudo-random patterns includes changing the last bit value to the previous bit value in the pseudo-random pattern for different bit periods.

20. The method of claim 17, wherein
the determining the second test pattern comprises
removing the first faults from the fault list;
generating the second test pattern, the second test pattern corresponding to the second faults in the fault list;
converting the second test pattern into bit information based on whether bit values of the second test pattern are repeated; and
converting the bit information into the compressed pattern based on a correspondence relationship.
